(19) United States
(12) Patent Application Publication
(10) Pub. No.: US 2009/0313943 A1
(43) Pub. Date: Dec. 24, 2009

(54) Apparatus and method for inserting valve assemblies into containers

(75) Inventor: R. Scott Corbin, Elgin, IL (US)

Correspondence Address: MILLER, MATTHIAS & HULL, ONE NORTH FRANKLIN STREET, SUITE 2350, CHICAGO, IL, 60606, US

(73) Assignee: Haumiller Engineering Company

(21) Appl. No.: 12/142,103

(22) Filed: Jun. 19, 2008

(51) Int. Cl. B65D 47/00; B23P 19/04

(52) U.S. Cl. 53/319; 29/700

(57) ABSTRACT

An automated, continuously operating apparatus for assembling valve assemblies onto containers includes a valve carrier using partial vacuum to secure valve assemblies during operation. The apparatus may further include a plurality of jaw assemblies for securing and/or straightening a dip tube, bag-on-valve, or other structure depending from the valve assembly prior to insertion into a container. The apparatus may include sub-assemblies that are adjustable relative to a base frame, thereby facilitating adjustment for container of different heights and to actuate different stroke lengths associated therewith. A defective valve assembly eject system may also be provided to prevent valve assemblies that do not have a dip tube or bag-on-valve from being entering the apparatus and being attached to a container.

### FIELD OF THE DISCLOSURE

The present disclosure generally relates to apparatus and methods for assembling parts, and for particularly to automated, continuous part assembly systems.

### BACKGROUND OF THE DISCLOSURE

Various types of automated assembly apparatus are generally known in the art. For example, apparatus is known for placing caps, actuators, or other devices onto the tops of containers. These devices typically use a rotary turret or dial. The containers and caps are separately fed into the dial and multiple cam-operated actuators simultaneously perform an assembly sequence, thereby assembling the parts in a continuous operation.

While known assembly systems generally perform adequately for certain applications, other types of parts are more difficult to handle. Aerosol containers, for example, will typically have a valve assembly that is attached to a top opening of a container. The valve assembly often includes a valve cup sized to close off the container opening and a dip tube extending a significant distance below the valve cup. The valve assembly may further include an actuator button attached to a valve stem to provide an interface that is more easily manipulated by a user. The dip tube, however, is typically formed of a flexible plastic material that can easily bend, and therefore more difficult to reliably insert into the container opening.

One conventional approach to the problem of dip tube insertion is to manually assemble the valves onto the containers. Manually assembly, however, is overly costly and slow.

Another approach is to use an automated assembly system. Conventional automated assembly systems, however, typically use friction fit or other mechanical engagement to secure and transfer one or more components to be assembled. Engaging the components in this manner, however, often necessitates additional machinery to strip or otherwise disengage the component from the apparatus. As a result, conventional automated assembly systems are overly complex and expensive. Additionally, many conventional systems use cams that are capable of producing a single stroke length, and therefore the cam and related components must be switched in order to run the system for a different container size. Accordingly, it is difficult and time consuming to adjust conventional automated systems for different container sizes and stroke lengths.

### SUMMARY OF THE DISCLOSURE

According to certain aspects of the present disclosure, an apparatus is provided for assembling valve assemblies onto containers, in which each container defines an opening and each valve assembly includes a cup sized for insertion into the container opening. The apparatus includes a cam defining a cam surface, a dial supported for rotation with respect to the stationary cam, and a plurality of container locators coupled to and spaced around the dial, each container locator being configured to receive a container. A plurality of valve inserters are coupled to the dial, each valve inserter including a cam follower positioned to engage the cam surface thereby to drive each valve inserter between retracted and extended positions along an assembly axis aligned with an associated container locator. Each valve inserter further includes a valve carrier having a connection end coupled to the cam follower and an engagement end configured to form a partial air tight seal with the valve assembly cup. A source of partial vacuum fluidly communicates with each valve carrier connection end, thereby to provide partial vacuum to the engagement end sufficient to hold the valve assembly against the valve carrier.

According to additional aspects, a method of inserting valve assemblies onto containers is provided in which each container defines an opening and each valve assembly include a cup sized for insertion into the container opening and a dip tube coupled to and extending below the cup. The method includes providing a plurality of containers in a container feeder and providing a plurality of valve assemblies in a valve assembly feeder. A container is transferred from the container feeder to a rotating container locator defining an assembly axis, and a valve assembly is transferred from the valve assembly feeder to a retracted position along the assembly axis with a valve inserter applying partial vacuum, the retracted position being spaced from the container. A guide surface is positioned at an initial position surrounding the assembly axis, the initial position being below and adjacent to the valve inserter. The guide surface is moved downwardly along the assembly axis to an actuated position adjacent the container opening. The valve inserter is moved downwardly along the assembly axis to an extended position adjacent the container opening. After initiating movement of the valve inserter from the retracted position to the extended position, the guide surface is withdrawn from the assembly axis. The valve assembly is deposited onto the container opening by removing the partial vacuum to the valve inserter, and the container and valve assembly are transferred to an outlet feeder.

According to further aspects, an apparatus for assembling valve assemblies onto containers is provided in which each container defines an opening and each valve assembly includes a cup sized for insertion into the container opening. The apparatus includes a cam defining a cam surface, a dial supported for rotation with respect to the stationary cam, and a plurality of container locators coupled to and spaced around the dial, each container locator being configured to receive a container. A plurality of valve inserters is coupled to the dial, each valve inserter including a cam follower positioned to engage the cam surface thereby to drive each valve inserter between retracted and extended positions along an assembly axis aligned with an associated container locator. A valve assembly feeder includes a valve feeder plate having receptacles sized to engage a first portion of each valve assembly and an outer guide rail configured to engage a second portion of each valve assembly. A gap is disposed between the valve feeder plate and the outer guide rail sized to receive a valve assembly dip tube, and an eject cutout is configured to allow the valve cup to slide therethrough. An ejector is aligned with the eject cutout and generates an eject force for biasing the valve cup toward the eject cutout.

According to still further aspects, an apparatus for assembling valve assemblies onto containers is provided in which each container defines an opening and each valve assembly includes a cup sized for insertion into the container opening. The apparatus includes a stationary sub-assembly including a base frame, a tabletop, an upper frame, and an upper support plate. A container sub-assembly includes a sub-platform coupled to the stationary sub-assembly by a first vertical adjustment mechanism. The sub-platform supports a drive shaft, a drive plate coupled to the drive shaft and defining receptacles configured to receive at least a portion of the containers, and an outer guide positioned around a portion of a periphery of the drive plate. A valve sub-assembly includes an upper platform coupled to the stationary sub-assembly by a second vertical adjustment mechanism. The upper platform supports a primary cam and a plurality of valve inserters operatively coupled to the cam and rotatable with respect to the cam.

### BRIEF DESCRIPTION OF THE DRAWINGS

For a more complete understanding of this disclosure, reference should be made to the embodiments illustrated in greater detail on the accompanying drawings, wherein:

FIG. 1 is a perspective view of a part assembly apparatus constructed according to the present disclosure;

FIG. 2 is a perspective view of a stationary sub-assembly used in the apparatus of FIG. 1;

FIG. 3 is a perspective view of a container sub-assembly used in the apparatus of FIG. 1;

FIG. 4 is a perspective view of a valve sub-assembly used in the apparatus of FIG. 1;

FIG. 5 is a perspective view of a valve positioning assembly used in the apparatus of FIG. 1;

FIG. 6 is an enlarged perspective view of a valve inserter used in the apparatus of FIG. 1;

FIG. 7 is an enlarged bottom perspective view of a valve carrier;

FIG. 8 is an enlarged top perspective view of the valve carrier of FIG. 7;

FIG. 9 is a perspective view of a container and valve assembly that may be assembled by the apparatus of FIG. 1;

FIG. 9A is a perspective view of an alternative valve assembly having a bag-on-valve;

FIG. 10 is an enlarged perspective view of first and second jaws of a jaw assembly used in the apparatus of FIG. 1;

FIG. 11 is an enlarged perspective view of a jaw actuator and jaw cam used in the apparatus of FIG. 1;

FIGS. 12A-E are schematic views of a valve inserter as it carrier out a valve insertion operation;

FIG. 13 is an enlarged perspective view of an alternative valve feeder having an eject system; and

FIG. 14 is an enlarged perspective view of the valve feeder system of FIG. 13.

It should be understood that the drawings are not necessarily to scale and that the disclosed embodiments are sometimes illustrated diagrammatical and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION OF THE DISCLOSURE

Methods and apparatus for continuously assembling valve containers are disclosed herein. Such valves may include an elongated dip tube extending therefrom. The methods and apparatus disclosed herein provide a jaw assembly for straightening the dip tube prior to insertion into the container. In addition, a cam system is provided that quickly and easily adjusts for different container heights and stroke lengths. Still further, the disclosed apparatus and methods may use partial vacuum to hold the valves as they are handled during assembly, thereby simplifying the assembly machinery. These and other advantages are disclosed more fully below.

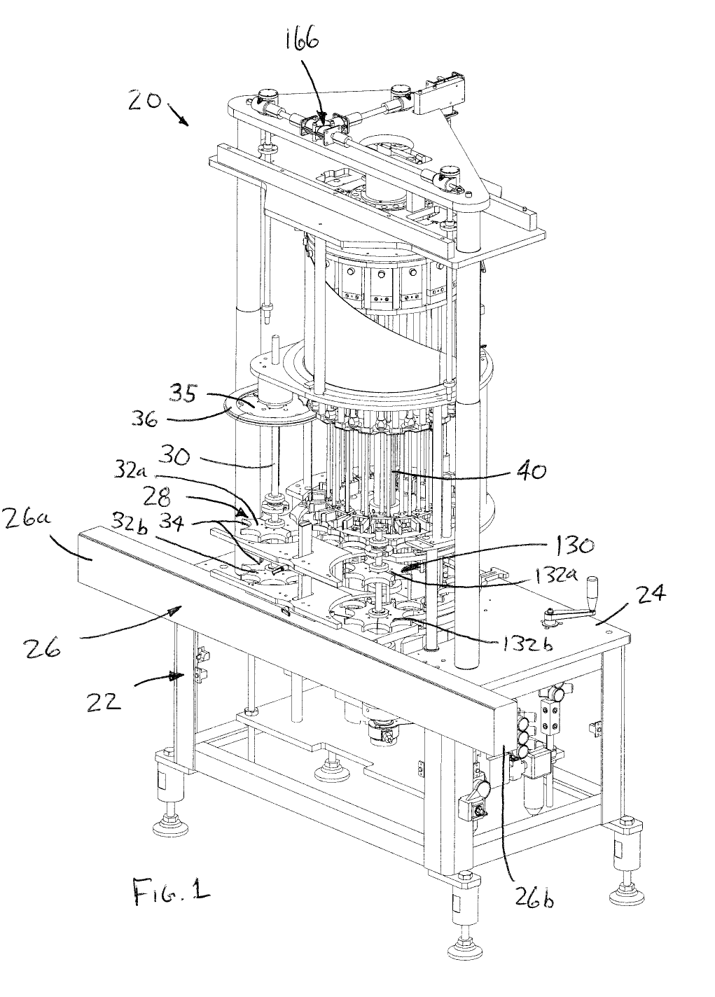

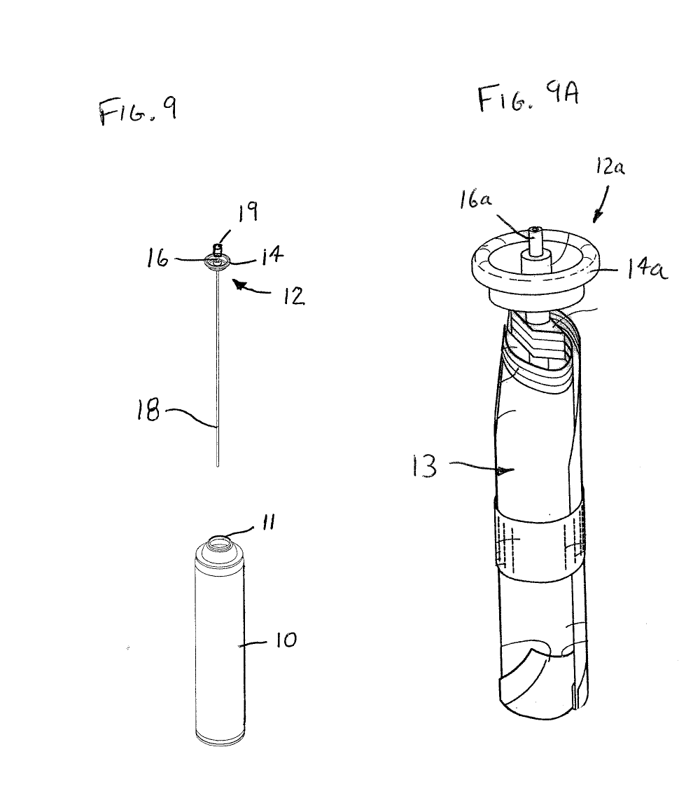

FIG. 1 is a perspective view of a part assembly apparatus 20 constructed according to the present disclosure. The apparatus 20 may be used to assemble a container, such as an aerosol container 10, to a valve assembly 12 (FIG. 9). The illustrated valve assembly 12 includes a valve cup 14 sized to fully cover an opening 11 formed in a top of the aerosol container 10. The cup 14 carries a discharge valve (not shown) having an outlet stem 16. A dip tube 18 is coupled to an inlet of the discharge valve and extends downwardly from the cup 14. The dip tube 18 is typically sufficiently long to reach a bottom of the container 10 when attached thereto, and therefore has a length that generally corresponds to the container height. An actuator button 19 may be coupled to the outlet stem 16 to facilitate actuation of the discharge valve. An alternative valve assembly 12a is illustrated in FIG. 9A having a bag-on-valve 13. The alternative valve assembly 12a includes a cup 14a and outlet stem 16a. While not shown in FIG. 9A, the alternative valve assembly 12a may also include an actuator button. It will further be appreciated that the methods and apparatus disclosed herein may be used with other types of valve assemblies without departing from the scope of the appended claims.

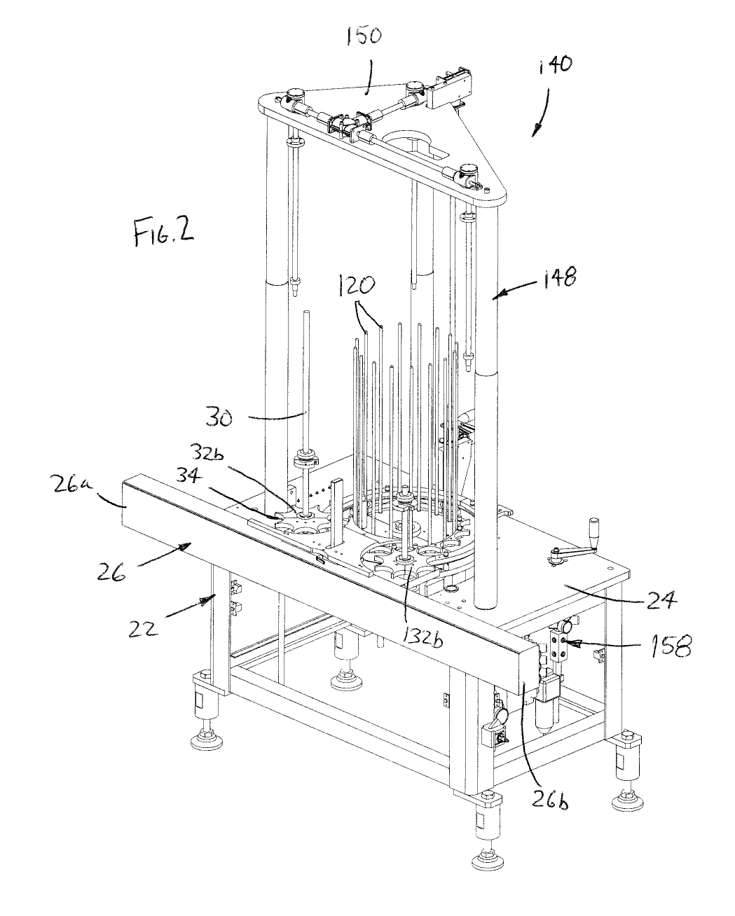

As best shown in FIGS. 1 and 2, the apparatus 20 includes a base frame 22 supporting a tabletop 24. A conveyor 26 may be positioned adjacent the tabletop 24 and has an upstream end 26a for feeding containers into the apparatus 20 and a downstream end 26b for carrying assembled containers and valves out of the apparatus 20. An inlet feeder 28 includes an inlet feeder shaft 30 operatively coupled to upper and lower container feeder plates 32a, 32b. The upper and lower plates 32a, 32b are formed with an array of retainers 34 sized to received a least a portion of a container. An assembly valve feeder plate 35 may also be operatively coupled to the inlet feeder shaft 30. An outer guide rail 36 is positioned around the valve feeder plate 35 to retain the valves as they are rotated about the valve feeder plate 35.

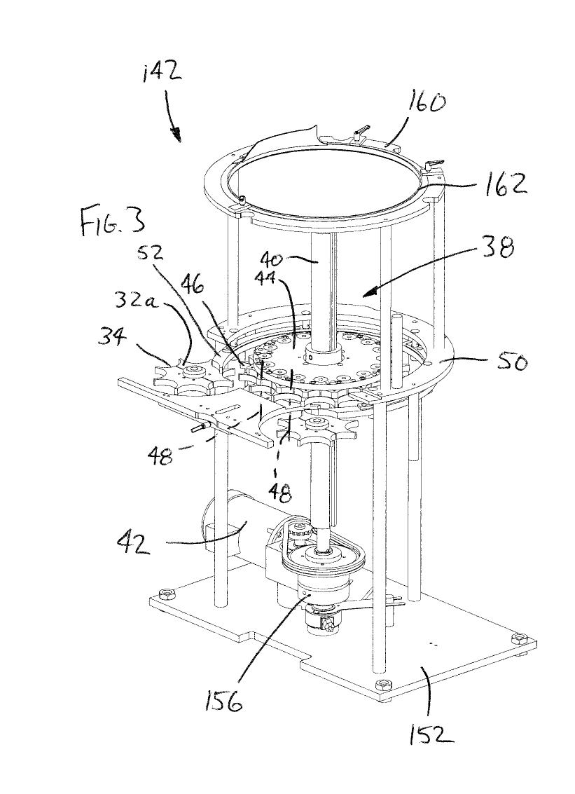

The apparatus 20 further includes a rotary dial 38 for continuously assembling containers 10 with valves 12. As best shown in FIGS. 1 and 3, the exemplary rotary dial 38 includes a drive shaft 40 extending through an opening in the tabletop 24 and having a lower end coupled to a motor 42. A drive plate 44 is coupled to the drive shaft 40 and is formed with container receptacles 46 sized to received at least a portion of the containers. Each container receptacle 46 has a semi-circular shape configured to closely engage a portion of an outer surface of the container side wall. As a result, each container is held in a precise location about a perimeter of the drive plate 44, with each container receptacle 46 defining a vertical assembly axis 48 along which a valve assembly 12 is inserted into a respective container 10 as the dial 38 rotates. Outer container guides 50, 52 extend around a portion of the drive plate 44 and to maintain engagement of the containers 10 with the drive plate 44 as it rotates with the drive shaft 40.

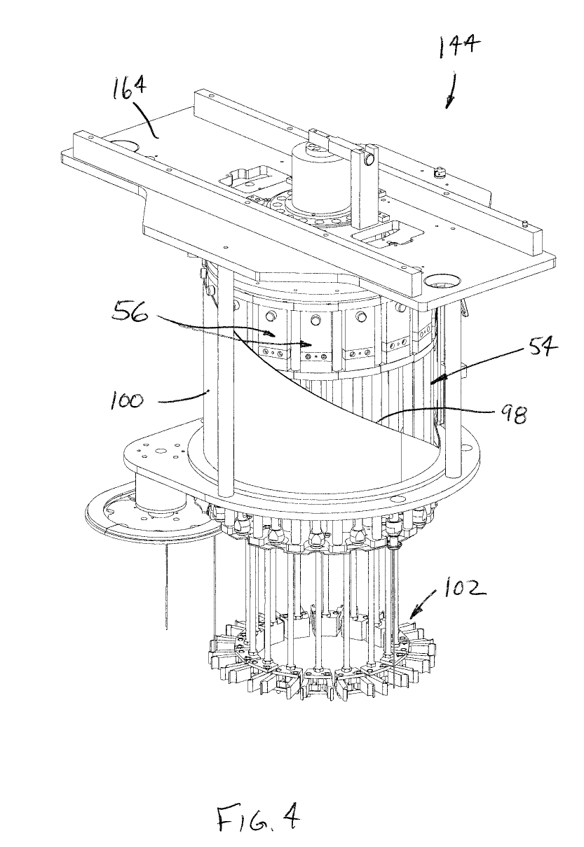

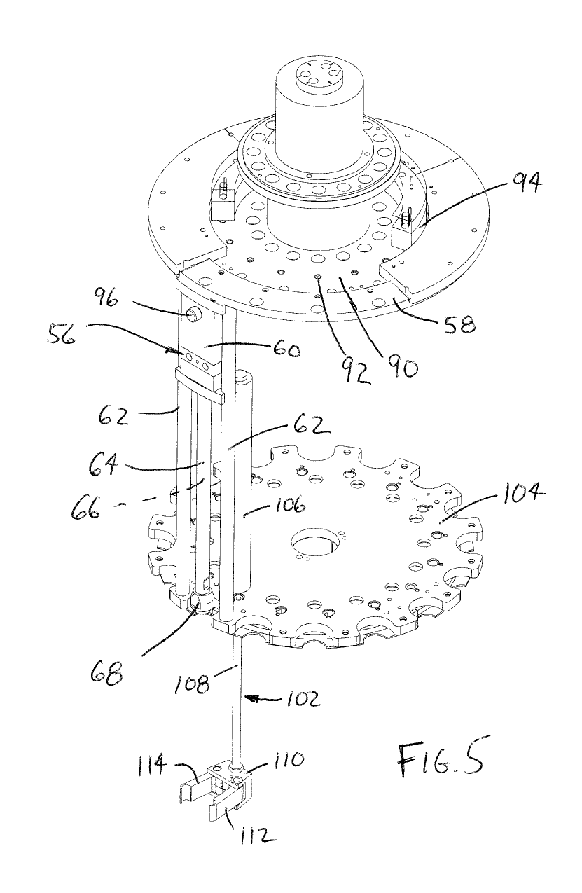

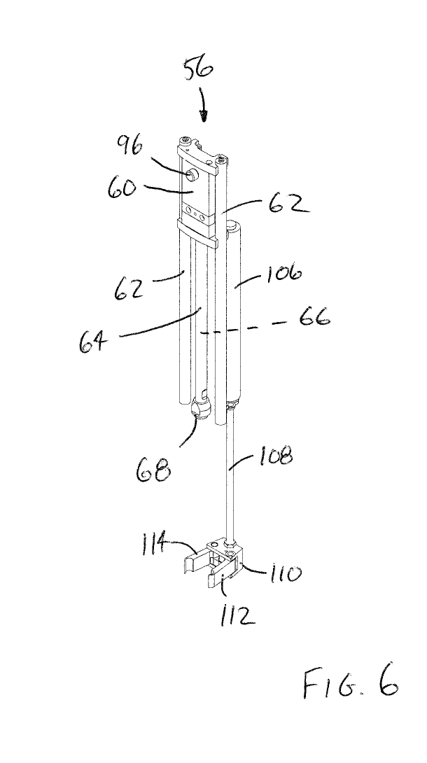

The rotary dial further includes a cam-driven valve positioning assembly 54, as best shown in FIGS. 1 and 4. The exemplary valve positioning assembly 54 includes a plurality of valve inserters 56 coupled to the drive-shaft 40 by an upper flange plate 58 (FIGS. 5 and 6). Each valve inserter 56 includes a base 60 slidably disposed between two adjacent guide posts 62, thereby allowing vertical movement of the base 60 along the guidepost 62. A conduit 64 is attached to a base 60 and defines an internal passage 66. A valve carrier 68 has a base end 70 coupled to the conduit 64 and an interface end 72 configured to form a partial air tight seal with the valve cup 14. Each valve carrier 68 is positioned so that it is axially aligned with an associated assembly axis 48.

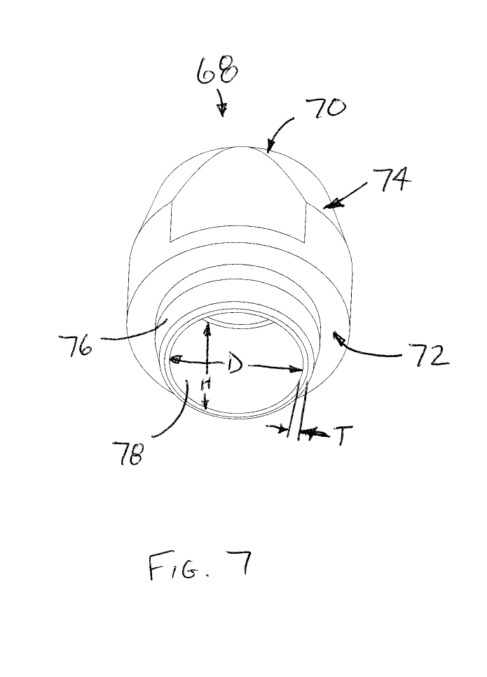

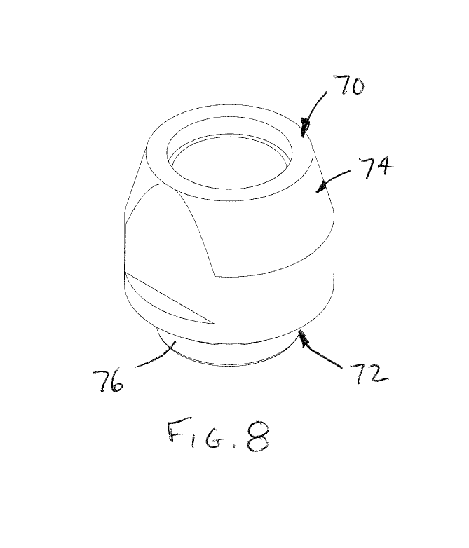

An exemplary valve carrier 68 is illustrated in greater detail at FIGS. 7 and 8. According to the illustrated embodiment, the valve carrier 68 has a generally annular-shaped body with a tapered upper portion 74 leading to the base end 70. The interface end 72 includes an annular wall 76 formed at a bottom of a valve carrier 68. The annular wall 76 defines a cylindrical inner surface 78 having a diameter D. The annular wall 76 also has a thickness T. The diameter D and thickness T are selected such that the interface end 72 will sufficiently mate with most standard valve cups. Additionally, the cylindrical surface 78 has a height H sufficient to accommodate both the outlet stem 16 extending upwardly from the valve cup 14 and an actuator button 19, which may or may not be coupled to the outlet stem 16. Accordingly, the exemplary valve carrier 68 may be used with a variety of valve cup 14 shapes and sizes as well as valve assemblies 12 that either include or omit a button actuator 19.

A fluid passage extends through each valve inserter 56 to communicate partial vacuum pressure from a vacuum source (not shown) to the interface end 72 of the valve carrier 68, thereby to provide a force for holding the valve assembly 12 in engagement with the valve carrier 68. Each valve inserter base 60 includes an internal passage extending between an inlet opening and an outlet opening. The outlet opening fluidly communicates with the conduit internal passage 66. As best shown in FIG. 5 a manifold plate 90 is formed with a plurality of inlet ports 92. Each inlet port 92 fluidly communicates with an associated inserter base internal passage to establish fluid communication between the manifold plate inlet port 92 and an associated valve carrier 68. The source of partial vacuum (not shown), in turn, communicates with the inlet ports 92.

Communication of partial vacuum to selected valve carriers 68 may be controlled by a mechanical device, such as a blocking shoe 94. The blocking shoe 94 is positioned to closely fit over the manifold 90 and is sized to obstruct only some of the inlet ports 92. The blocking shoe 94 does not rotate, and therefore the particular inlet ports 92 it blocks will change as the manifold 90 rotates with the drive shaft 40. When the blocking shoe 94 is positioned over an inlet port 92, it prevents fluid communication between the vacuum source and the valve carrier 68, thereby cutting off the partial vacuum pressure supplied to the valve carrier 68.

In operation, unobstructed inlet ports 92 communicate partial vacuum to associated valve carriers 68, thereby providing a vacuum force for holding a valve assembly in engagement with a valve carrier 68. As the manifold plate 90 rotates with the drive shaft 40, however, the inlet port 92 is eventually obstructed by the blocking shoe 94, thereby removing the removing the vacuum force and allowing the valve assembly to drop under the force of gravity.

Vertical movement of the valve inserters 56 is provided by a cam and follower system. As best shown in FIG. 5, each valve inserter base 60 includes a cam follower 96 projected outwardly therefrom. The cam follower is configured to engage a cam surface 98 of a stationery cam 100. Accordingly, as the valve inserters 56 rotate with the drive shaft 40, the cam followers 96 will force the valve inserters 56 up and down, as defined by the cam surface 98.

The valve positioning assembly 54 further includes a plurality of jaw assemblies 102 supported for rotation with the drive shaft 40. As best shown in FIGS. 5 and 6, the jaw assemblies 102 are supported by a lower flange plate 104 mechanically coupled to the drive shaft 40. Each jaw assembly 102 includes a slide actuator, such as air cylinder 106. The air cylinder 106 has a shaft 108 capable of reciprocating along a vertical axis. A jaw base 110 is coupled to the shaft 108. First and second jaw arms 112, 114 are pivotably coupled to the jaw base 110.

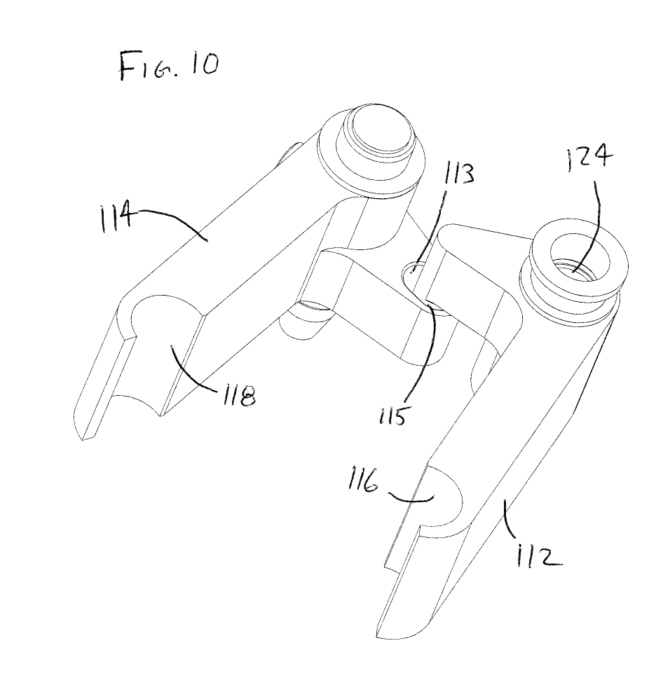

The first jaw arm 112 may be mechanically linked to the second jaw arm 114 so that both arms 112, 114 move in unison, as shown in FIG. 10. In the illustrated embodiment, the second arm 114 has a slot 113 sized to receive a post 115 extending from the first arm 112. Accordingly, movement of the first arm 112 will cause movement of the second arm 114. The first and second jaw arms 112, 114 are movably relative to each other between an open position in which distal ends of the arms are spaced from each other, and a closed position, in which the distal ends engage each other. The distal ends of the first and second jaw arms 112, 114 include first and second guide surface sections 116, 118 respectively. In the illustrated embodiment, the first and second guide surface section 116, 118 have partial cylindrical shapes. When the arms 112, 114 are in the closed position, the guide surface sections 116, 118 form a closed, complete cylindrical guide surface. The guide surface may be sized to accommodate a dip tube 18 (FIG. 9), bag-on-valve 13 (FIG. 9A), or other component depending from the valve cup 14. The first and second jaw arms 112, 114 are configured so that the guide surface surrounds the assembly axis 48 when the arms are in the closed position.

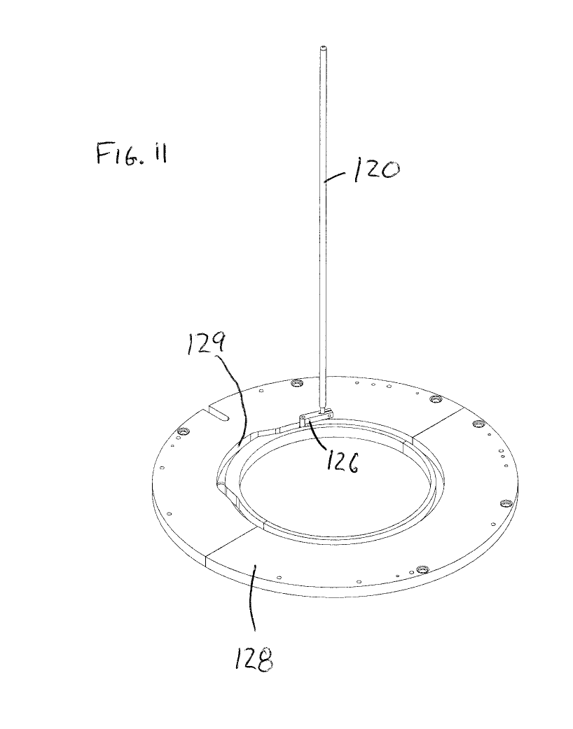

A separate jaw actuator may be provided to actuate the first and second jaw arms 112, 114 between the open and closed positions. In the exemplary embodiment, the jaw actuator is shown as a splined rod 120 (FIG. 2) coupled to a base plate 122 positioned below the table top 24. The upper end of each splined rod 120 extends through a spline-shaped socket 124 (FIG. 10) extending through the first jaw arm 112. Accordingly, rotation of the splined rod 120 will cause rotation of the first jaw arm 112. The second jaw arm 114 will also rotate due to its mechanical connection to the first jaw arm 112. A bottom end of each splined rod 120 includes a cam follower 126 (FIG. 11). A lower cam plate 128 includes a jaw cam surface 129 configured to engage the lower cam followers 126 thereby to drive rotation of the splined rods as desired.

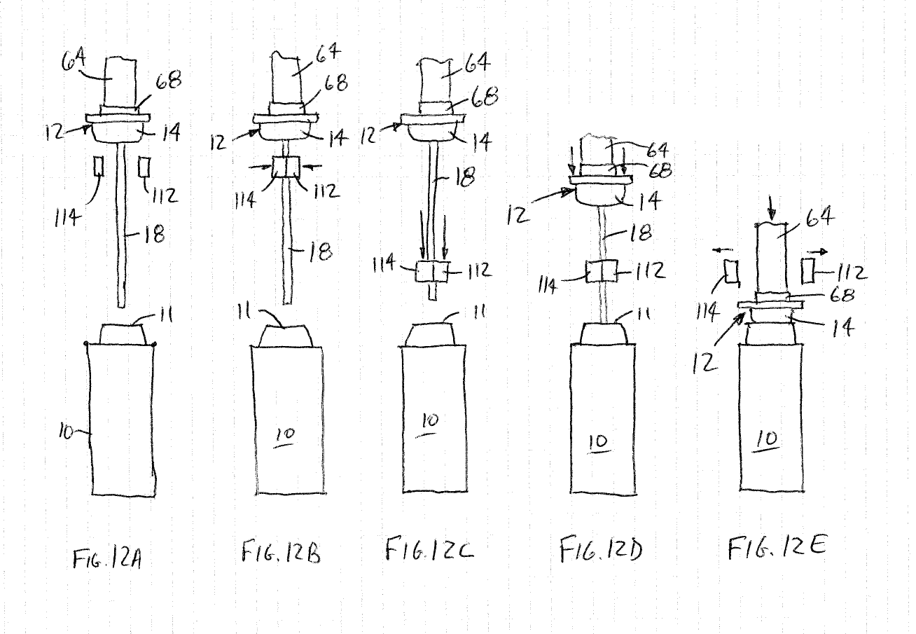

The jaw assemblies 42 are used to straighten and align depending portions of the valve assemblies prior to insertion into associated containers 10. Accordingly, with the arms 112, 114 in the open configuration, the jaw assembly 102 may be placed in an initial position where the jaw arms 112, 114 are near an associated valve carrier 68 and just below a valve cup 14 carried by the valve carrier 68, as shown in FIG. 12A. The jaw arms 112, 114 may then be actuated to the closed position to form a complete guide surface surrounding an upper end of the dip tube 18, as shown in FIG. 12B. Next, the air cylinder 106 may be extended so that the jaw assembly moves to an actuated position with the jaw arms 112, 114 located relatively farther from the valve carrier 68 and nearer a lower end of the dip tube, as shown in FIG. 12C. In this position, the jaw arms 112, 114 are also located adjacent the container opening 11. As the drive shaft 40 further rotates, the valve inserter 56 moves from an upper retracted position to a lower extended position, thereby bringing the valve cup closer to the associated container as shown in FIG. 12D. As the valve inserter 56 moves downwardly, the jaw arms 112, 114 are returned to the open position to prevent interference with the downwardly moving valve inserter 56. When the valve inserter 56 reaches its fully extended position, the valve cup is located adjacent the container opening and the dip tube has been guided into the interior of the container, as shown in FIG. 12E. Partial vacuum may then be cut off from the valve carrier 68 thereby allowing the valve cup to drop into place on top of the container. The valve inserter 56 and jaw assembly 102 are then returned to their initial positions and the same process may be repeated. While this process has been described for a valve assembly 12 having a dip tube 18, it may also be used on a valve assembly having a bag-on-valve 13 (FIG. 9A) or other type of valve assembly.

The part assembly apparatus 20 further includes an outlet feeder 130 positioned to transfer assembled containers and valves from the rotary dial 38 to the conveyor downstream end 26b. The outlet feeder 130 includes upper and lower feeder plates 132a, 132b (FIG. 1).

According to certain aspects of the present disclosure, a method of inserting valve assemblies onto containers is provided. As noted above, each container 10 defines an opening 11 and each valve assembly 12 includes a cup 14 sized for insertion into the container opening 11. Each valve assembly 12 may further include a dip tube 18 coupled to and extending below the valve cup 14 (FIG. 9). Alternatively, the valve assembly may be a bag-on-valve type (FIG. 9A) or other type of valve assembly. A plurality of containers 10 is provided in the container feeder while a plurality of valve assemblies 12 is provided in a valve assembly feeder. The method includes transferring a container 10 from the container feeder to a rotating container locator which defines an assembly axis. The locator may be the container receptacles 46 of the drive plate 44. A valve assembly 12 is transferred from the valve assembly feeder to a retracted position along the assembly axis 48 by a valve inserter 56 applying partial vacuum. The retracted position is spaced from the container 10. Next, a guide surface is positioned at an initial position surrounding the assembly axis 48 wherein the initial position is located below and adjacent to the valve inserter 56. The guide surface is moved downwardly along the axis 48 to an actuated position adjacent the container opening 11. The valve inserter 56 is then moved downwardly along the assembly axis 48 to an extended position, in which the valve cup 14 is adjacent the container opening 11. The guide surface is initially maintained in position as the valve inserter 56 moves downwardly, thereby to guide the dip tube 18 (or bag-on-valve 13) into the container opening 11. Subsequently, the guide surface is withdrawn from the assembly axis to allow the valve inserter 56 to move fully to the extended position. Once the valve inserter 56 has reached the extended position, the valve assembly 12 is deposited onto the container opening 11 by removing the partial vacuum to the valve inserter 56. The assembled container and valve assembly are then transferred to an outlet feeder.

As noted above, the guide surface may be defined by a pair of first and second jaw arms 112, 114. The jaw arms 112, 114 may be movable between open and closed positions. Accordingly, when the guide surface is placed in the initial position, the first and second jaw arms 112, 114 may be actuated to the closed position, thereby to define the guide surface. The first and second jaw arms 112, 114 are maintained in the closed position as the guide surface is moved to the actuated position. Still further, the first and second jaw arms 112, 114 may be actuated to the open position to allow the guide surface to be withdrawn from the assembly axis 48.

According to additional aspects of the present disclosure, the part assembly apparatus 20 is configured to allow automatic adjustments for different container heights without requiring components such as the cam 100 to be changed. The components of the apparatus 20 described above may be divided into three main subsystems: (1) a stationary sub-assembly 140 that includes all components that remain stationary, as shown in FIG. 2; (2) a container sub-assembly 142 that primarily includes components that engage and move the containers 10, illustrated in FIG. 3; and (3) a valve sub-assembly 144 that primarily includes components that engage and move the valve assemblies 12, illustrated in FIG. 4. The container and valve sub-assemblies 142, 144 are movable with respect to the stationery sub-assembly, thereby allowing the apparatus to run containers having different heights.

The stationary sub-assembly 140, best shown in FIG. 2, includes the base frame 22 and tabletop 24. The stationary sub-assembly 140 further includes an upper frame 148 and upper support plate 150. The splined rods 120 used to actuate the jaw assemblies 102 are also part of the stationary sub-assembly 140. Accordingly, the splined receptacles 124 allow the jaw assemblies 102 to move up and down the splined rods 120 as the height of the valve sub-assembly 144 is adjusted while still maintaining operative association therebetween.

The illustrated container sub-assembly 142 includes a sub-platform 152 fixedly coupled to the outer guides 50, 52 (FIG. 3). The sub-platform 152 supports the motor 42 and a rotating hub 156. The motor 154 is operatively coupled to the hub 156 and the hub is coupled to the drive shaft 40. An adjustment mechanism, such as rotatable screw drive 158 (FIG. 1), is operatively coupled to the sub-platform 152 and may be rotated in either direction to raise or lower the sub-platform 152 and, consequently, the entire container sub-assembly 142, with respect to the stationary sub-assembly 140. Accordingly, the height of the upper container feeder plate 32a, upper feeder plate 132a, drive plate 44 and container receptacles 46, and outer guides 50, 52 are adjusted so that they will engage in an upper portion of each container 10. The container sub-assembly 142 further includes a secondary cam 160 defining a cam-surface 162 supported a pre-determined distance above the outer guides 50, 52. Referring to FIGS. 1 and 3, when the container sub-assembly 150 is raised, the secondary cam 160 will be positioned to engage the cam followers 96 of the valve inserters 56 as they are rotated with the dial 38, thereby limiting the stroke height executed by the valve inserters 56.

The valve component sub-assembly 144 is illustrated in FIG. 4 and includes an upper platform 164 that supports the cam 100 and valve inserters 56. The cam 100 is fixed to the upper platform 164 while the valve inserters 156 are supported for rotation with respect to the upper platform 164. Another height adjustment mechanism, such as a screw drive system 166 (FIG. 1), is operatively coupled to the upper platform 164 to allow the height of the valve component sub-assembly 144 to be adjusted with respect to the stationary sub-assembly 140.

In operation, the assembly apparatus 20 may be quickly and easily adjusted to a particular container height by moving the container sub-assembly 142 as needed. A corresponding adjustment for stroke height (which is largely dependent on container height) may be subsequently or simultaneously made by adjusting the position of the valve sub-assembly 144. The secondary cam 160 will override at least a portion of the primary cam to limit the stroke length executed by the valve carriers 68 as the drive shaft 40 rotates.

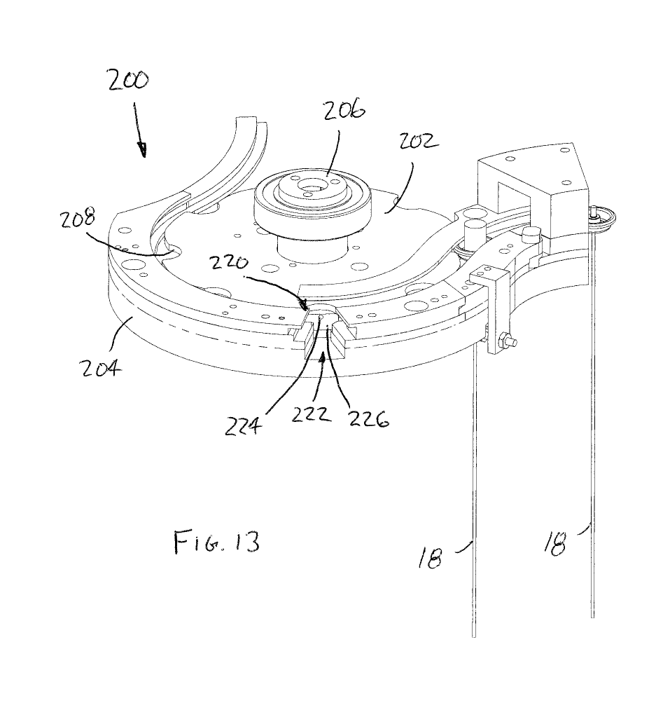

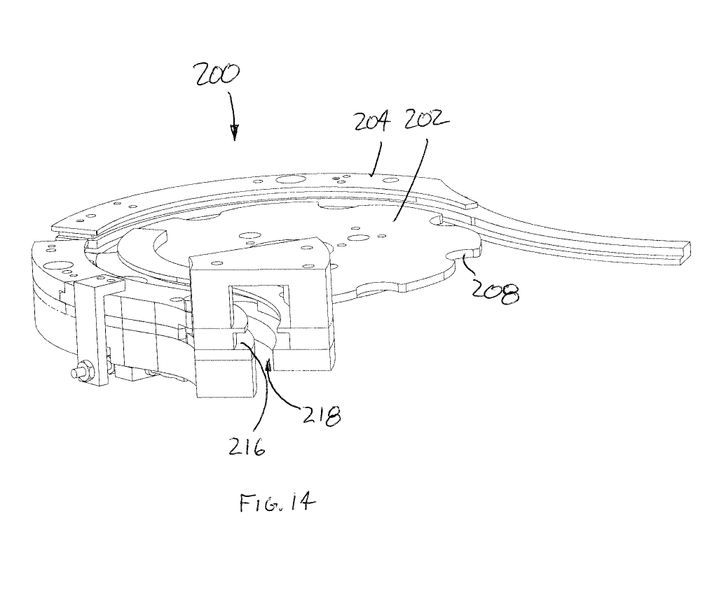

An alternative embodiment of a valve feeder 200 is illustrated in FIGS. 13 and 14 and incorporates a reject system for preventing defective valve assemblies from entering the part assembly apparatus. The valve assembly feeder 200 includes a valve feeder plate 202 and an outer guide rail 204. The valve feeder plate 202 is supported for rotation about a hub 206 that may be operatively coupled to the feeder shaft 30. An outer periphery of the valve feeder plate 202 is formed with receptacles 208 configured to engage a portion of the valve assembly 12. In the illustrated embodiment, the receptacles 208 are configured to closely fit a portion of the valve cup 14 of the valve assembly 12. The outer guide rail 204 is similarly configured to support a portion of the valve assembly 12. In the illustrated embodiment, the outer guide rail 204 includes an outer groove 216 configured to engage a bottom surface of the valve cup 14. The outer guide rail 204 is positioned to form a gap 218 between the rail 204 and the valve feeder plate 202, wherein the gap 218 is sized to allow the dip tube 18 of the valve assembly 12 to extend therethough, as shown in FIG. 13. In operation, valve assemblies 12 are fed into the valve feeder 200 so that one side of each valve assembly 12 is supported by the outer guide rail groove 216 while an opposite side of the valve assembly 12 is supported by a plate receptacles 208. The valve feeder plate 202 is rotated to advance the valve assemblies 210 along the outer guide rail 204.

The valve feeder includes a eject system 220 to remove any valve assemblies 12 that do not include a dip tube 18. As best shown in FIG. 13, the exemplary eject system 220 includes an eject cutout 222 formed in the outer guide rail 204 and configured to allow a valve cup 14 to slide therethrough. Additionally, a valve assembly ejector is aligned with the eject cutout 222 and positioned on an opposite side of the outer guide rail groove 216. In the illustrated embodiment, ejector is a stream of pressurized fluid exiting an outlet port 224 formed in an ejector manifold 226. A source of pressurized fluid (not shown) fluidly communicates with the ejector manifold 226. Accordingly, as the valve assemblies 210 advance to a position between the outlet port 224 and the eject cutout 222, the pressurized fluid exiting the outlet port 224 will exert an eject force which tends to push the valve cup 14 of the valve assembly 12 through the eject cutout 222. As long as the valve assembly 12 includes a dip tube 18, the eject force will be resisted and the valve assembly 12 will remain in place. If, however, the valve assembly 12 is defective and does not include a dip tube 18, the force will eject the valve cup 14 and any other components of the valve assembly 12 through the eject cutout 222, thereby preventing an incomplete valve assembly from being attached to a container 10.

While only certain embodiments have been set forth, alternatives and modifications will be apparent from the above description to those skilled in the art. These and other alternatives are considered equivalents and within the spirit and scope of this disclosure and the appended claims.

What is claimed is:

1. Apparatus for assembling valve assemblies onto containers, in which each container defines an opening and each valve assembly includes a cup sized for insertion into the container opening, the apparatus comprising:
a cam defining a cam surface;
a dial supported for rotation with respect to the stationary cam;
a plurality of container locators coupled to and spaced around the dial, each container locator being configured to receive a container;
a plurality of valve inserters coupled to the dial, each valve inserter including a cam follower positioned to engage the cam surface thereby to drive each valve inserter between retracted and extended positions along an assembly axis aligned with an associated container locator, and a valve carrier having a connection end coupled to the cam follower and an engagement end configured to form a partial air tight seal with the valve assembly cup; and
a source of partial vacuum fluidly communicating with each valve carrier connection end, thereby to provide partial vacuum to the engagement end sufficient to hold the valve assembly against the valve carrier.

2. The apparatus of claim 1, further including a plurality of jaw assemblies, each jaw assembly including a slide actuator coupled to the dial, a jaw base coupled to the slide actuator, a first jaw arm coupled to the jaw base and having a distal end, a second jaw arm coupled to the jaw base and having a distal end, wherein the first and second jaw arms are movable relative to each other between an open position in which the distal ends are spaced from each other and a closed position in which the distal ends engage each other, and a jaw actuator coupled to the first and second jaw arms for moving the arms between the open and closed positions.

3. The apparatus of claim 2, in which the first jaw arm distal end defines a first guide surface section and the second jaw arm distal end defines a second guide surface section, wherein the first and second guide surface sections form a contiguous guide surface surrounding the assembly axis when the first and second jaw arms are in the closed position.

4. The apparatus of claim 3, in which the slide actuator moves the first and second jaw arms along the assembly axis from an initial position, located relatively nearer to the valve carrier, to an actuated position, located relatively farther from the valve carrier.

5. The apparatus of claim 2, in which the first jaw arm is mechanically coupled to the second jaw arm.

6. The apparatus of claim 5, in which the jaw actuator comprises an actuator rod coupled to the first jaw arm and a cam follower coupled to the actuator rod, the apparatus further including a second stationary cam configured to engage jaw actuator cam follower thereby to actuate the first and second jaw arms between the open and closed positions.

7. A method of inserting valve assemblies onto containers, in which each container defines an opening and each valve assembly include a cup sized for insertion into the container opening and a dip tube coupled to and extending below the cup, the method comprising:
providing a plurality of containers in a container feeder;
providing a plurality of valve assemblies in a valve assembly feeder;
transferring a container from the container feeder to a rotating container locator defining an assembly axis;
transferring a valve assembly from the valve assembly feeder to a retracted position along the assembly axis with a valve inserter applying partial vacuum, the retracted position being spaced from the container;
positioning a guide surface at an initial position surrounding the assembly axis, the initial position being below and adjacent to the valve inserter;
moving the guide surface downwardly along the assembly axis to an actuated position adjacent the container opening;
moving the valve inserter downwardly along the assembly axis to an extended position adjacent the container opening;
after initiating movement of the valve inserter from the retracted position to the extended position, withdrawing the guide surface from the assembly axis;
depositing the valve assembly onto the container opening by removing the partial vacuum to the valve inserter; and
transferring the container and valve assembly to an outlet feeder.

8. The method of claim 7, in which the valve inserter is actuated by a cam.

9. The method of claim 7, in which the guide surface is defined by a pair of first and second jaw arms disposed in a closed position, the first and second jaw arms being movable to an open position.

10. The method of claim 9, in which positioning the guide surface in the initial position comprises actuating the first and second jaw arms to the closed position.

11. The method of claim 10, in which moving the guide surface to the actuated position comprises maintaining the first and second jaw arms in the closed position.

12. The method of claim 11, in which withdrawing the guide surface from the assembly axis comprises actuating the first and second jaw arms to the open position.

13. Apparatus for assembling valve assemblies onto containers, in which each container defines an opening and each valve assembly includes a cup sized for insertion into the container opening, the apparatus comprising:
a cam defining a cam surface;
a dial supported for rotation with respect to the stationary cam;
a plurality of container locators coupled to and spaced around the dial, each container locator being configured to receive a container;
a plurality of valve inserters coupled to the dial, each valve inserter including a cam follower positioned to engage the cam surface thereby to drive each valve inserter between retracted and extended positions along an assembly axis aligned with an associated container locator; and
a valve assembly feeder including a valve feeder plate having receptacles sized to engage a first portion of each valve assembly, an outer guide rail configured to engage a second portion of each valve assembly, a gap disposed between the valve feeder plate and the outer guide rail sized to receive a valve assembly dip tube, an eject cutout configured to allow the valve cup to slide therethrough, and an ejector aligned with the eject cutout and generating an eject force for biasing the valve cup toward the eject cutout.

14. The apparatus of claim 13, in which the ejector comprises an ejector manifold defining an outlet port oriented to direct a stream of pressurized fluid toward the eject cutout.

15. Apparatus for assembling valve assemblies onto containers, in which each container defines an opening and each valve assembly includes a cup sized for insertion into the container opening, the apparatus comprising:
a stationary sub-assembly including a base frame, a tabletop, an upper frame, and an upper support plate;
a container sub-assembly including a sub-platform coupled to the stationary sub-assembly by a first vertical adjustment mechanism, the sub-platform supporting a drive shaft, a drive plate coupled to the drive shaft and defining receptacles configured to receive at least a portion of the containers, and an outer guide positioned around a portion of a periphery of the drive plate; and
a valve sub-assembly including an upper platform coupled to the stationary sub-assembly by a second vertical adjustment mechanism, the upper platform supporting a primary cam, and a plurality of valve inserters operatively coupled to the cam and rotatable with respect to the cam.

16. The apparatus of claim 15, in which the container sub-assembly further includes a secondary cam positioned above the outer guides and configured to override the primary cam when the valve sub-assembly is lowered with respect to the stationary sub-assembly.

17. The apparatus of claim 15, in which the valve sub-assembly further includes a jaw assembly for each valve inserter.

18. The apparatus of claim 17, in which the stationary sub-assembly includes a jaw actuator for each jaw assembly, wherein each jaw actuator is slidably coupled to the jaw assembly to move the jaw assembly between open and closed positions.
